(19) United States
(12) Patent Application Publication
(10) Pub. No.: US 2021/0328321 A1
(43) Pub. Date: Oct. 21, 2021

(54) TRANSMISSION LINE USING NANOSTRUCTURED MATERIAL FORMED THROUGH ELECTROSPINNING AND METHOD OF MANUFACTURING THE TRANSMISSION LINE

(71) Applicant: SENSORVIEW INCORPORATED, Gyeonggi-do (KR)

(72) Inventors: Byoung Nam KIM, Gyeonggi-do (KR); Kyoung Il KANG, Gyeonggi-do (KR)

(21) Appl. No.: 17/269,561

(22) PCT Filed: Aug. 30, 2019
(86) PCT No.: PCT/KR2019/011116

§ 371 Date: Feb. 19, 2021

(30) Foreign Application Priority Data
Aug. 31, 2018 (KR) 10-2018-0103930

(51) Int. Cl. H01P 11/00; H01P 3/08; D01D 5/00

(52) U.S. Cl. CPC H01P 11/003; H01P 3/08; D01D 5/0038; H01P 3/088; H01P 3/081

(57) ABSTRACT

Disclosed are a transmission line using a nanostructured material and a method of manufacturing the transmission line. The transmission line includes a first nanoflon layer formed of nanoflon, above which a first coating layer formed of an insulating material is formed, and below which a second coating layer formed of an insulating material is formed, a first pattern formed by a first conductive layer formed on the first coating layer, and a first ground layer formed below the second coating layer.

### CROSS-REFERENCE TO RELATED APPLICATION

This application claims priority to and the benefit of Korean Patent Application No. 2018-0103930, filed on Aug. 31, 2018, the disclosure of which is incorporated herein by reference in its entirety.

### FIELD

The present invention relates to a transmission line, and more particularly, to a transmission line using a nanostructured material formed by electrospinning a liquid resin at a high voltage and a method of manufacturing the transmission line.

### BACKGROUND

In order to transmit or treat a superhigh frequency signal at a small loss, a low-loss and high performance transmission line is necessary. Generally, losses at a transmission line are roughly divided into a conductor loss caused by a metal and a dielectric loss caused by a dielectric. Particularly, a loss caused by a dielectric increases when permittivity of the dielectric is higher, and a power loss increases when resistance is greater.

Accordingly, in order to manufacture a low-loss and high performance transmission line for transmitting a superhigh frequency signal, it is necessary to use a material having low permittivity and a small loss tangent value. Particularly, in order to efficiently transmit a signal having a frequency in a band of from 3.5 GHz to 28 GHz used in a five generation (5G) mobile communication network, the significance of a transmission line which has a low loss even in a superhigh frequency band increases more and more.

### SUMMARY

The present invention is directed to providing a method of manufacturing a transmission line using coating of a nanostructured material formed through electrospinning, which has low permittivity and is capable of reducing a loss tangent value at the low permittivity to reduce a loss at a transmission line caused by a dielectric to satisfy necessity for a low-loss and high performance transmission line.

According to one aspect of the present invention, there is a transmission line including a first nanoflon layer formed of nanoflon, above which a first coating layer formed of an insulating material is formed, and below which a second coating layer formed of an insulating material is formed, a first pattern formed by a first conductive layer formed on the first coating layer, and a first ground layer formed below the second coating layer. Here, the nanoflon is a nanostructured material formed by electrospinning a liquid resin at a high voltage.

The first pattern may include ground lines and a signal line, which are formed by etching the first conductive layer.

The transmission line may further include a second nanoflon layer located on the first pattern formed on the first coating layer and the first coating layer exposed by the etching and above which a third coating layer formed of an insulating material is provided and a second ground layer formed on the third coating layer.

The transmission line may further include a second nanoflon layer located on the first pattern formed on the first coating layer and the first coating layer exposed by the etching and above which a third coating layer formed of an insulating material is formed, a second ground layer formed on the third coating layer, a third nanoflon layer formed on the second ground layer, above which a fourth coating layer formed of an insulating material is provided, and below which a fifth coating layer formed of an insulating material is provided, a second conductive layer formed on the fourth coating layer, and a second pattern formed by etching the second conductive layer and configured to transmit a signal. The second pattern may include ground lines and a signal line configured to transmit a signal, which are formed by etching the second conductive layer.

The transmission line may further include a fourth nanoflon layer located on the second pattern formed on the fourth coating layer and the fourth coating layer exposed by the etching and above which a sixth coating layer formed of an insulating material is provided and a third ground layer formed on the sixth coating layer.

The locating may be adhesion using an adhesive tape, an adhesive, or thermal adhesion in which heat is applied to an adhesive tape. The first to sixth coating layers may be polyimide (Pl), and the conductive layers may be copper (Cu).

According to another aspect of the present invention, there is provided a method of manufacturing a transmission line using a nanostructured material formed through electrospinning. The method includes forming a first coating layer and a second coating layer on a top and a bottom of a first nanoflon layer formed of nanoflon, respectively, by coating the top and bottom with an insulating material, forming a first conductive layer on the first coating layer, forming a first pattern, which transmits and receives a signal, by etching the first conductive layer, and forming a first ground layer on the second coating layer. Here, the nanoflon is a nanostructured material formed by electrospinning a liquid resin at a high voltage.

The forming of the first pattern may include forming ground lines and a signal line by etching the first conductive layer.

The method may further include locating a second nanoflon layer located on the first pattern formed on the first coating layer and the first coating layer exposed by the etching and above which a third coating layer formed of an insulating material is provided and forming a second ground layer formed on the third coating layer.

The method may further include locating a second nanoflon layer located on the first pattern formed on the first coating layer and the first coating layer exposed by the etching and above which a third coating layer formed of an insulating material is provided and forming a second ground layer formed on the third coating layer.

The method may further include forming a fourth coating layer and a fifth coating layer on a top and a bottom of a third nanoflon layer formed of nanoflon, respectively, by coating the top and bottom with an insulating material, forming the third nanoflon layer on the second ground layer, above which the fourth coating layer is formed and below which the fifth coating layer is formed, forming a second conductive layer on the fourth coating layer, and forming a second pattern, which transmits and receives a signal, by etching the second conductive layer.

The method may further include locating a fourth nanoflon layer, above which a sixth coating layer formed of an insulating material is formed, on the second pattern formed on the fourth coating layer and the fourth coating layer exposed by the etching and forming a third ground layer on the fourth nanoflon layer. The locating may be adhesion using an adhesive tape, an adhesive, or thermal adhesion in which heat is applied to an adhesive tape.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates an example of an apparatus which manufactures nanoflon through electrospinning;

FIG. 2 illustrates an example of a stripline transmission line;

FIG. 3A is a cross-sectional view illustrating a first embodiment of a transmission line using a nanostructured material formed through electrospinning according to the present invention;

FIG. 3B illustrates a first nanoflon layer having a top and a bottom coated with an insulating material;

FIG. 4 is a cross-sectional view of the transmission line and illustrates adhesion to the first nanoflon layer according to the transmission line using the nanostructured material through electrospinning according to the present invention;

FIG. 5 is a cross-sectional view illustrating a second embodiment of the transmission line using the nanostructured material through electrospinning according to the present invention;

FIG. 6 is a cross-sectional view illustrating a third embodiment of the transmission line using the nanostructured material through electrospinning according to the present invention;

FIG. 7 is a cross-sectional view of the transmission line and illustrates adhesion to a second nanoflon layer according to the transmission line using the nanostructured material through electrospinning according to the present invention;

FIG. 8 is a cross-sectional view illustrating a fourth embodiment of the transmission line using the nanostructured material through electrospinning according to the present invention;

FIG. 9 is a cross-sectional view illustrating a fifth embodiment of the transmission line using the nanostructured material through electrospinning according to the present invention;

FIG. 10 is a cross-sectional view illustrating a sixth embodiment of the transmission line using the nanostructured material through electrospinning according to the present invention;

FIGS. 11A, 11B, and 11C illustrate a first embodiment of a method of manufacturing a transmission line using a nanostructured material formed through electrospinning according to the present invention;

FIG. 12 illustrates a second embodiment of the method of manufacturing the transmission line using the nanostructured material formed through electrospinning according to the present invention;

FIGS. 13A and 13B illustrate a third embodiment of the method of manufacturing the transmission line using the nanostructured material according to the present invention;

FIGS. 14A and 14B illustrate a fourth embodiment of the method of manufacturing the transmission line using the nanostructured material formed through electrospinning according to the present invention;

FIGS. 15A, 15B, and 15C illustrate a fifth embodiment of the method of manufacturing the transmission line using the nanostructured material formed through electrospinning according to the present invention;

FIGS. 16A and 16B illustrate a sixth embodiment of the method of manufacturing the transmission line using the nanostructured material formed through electrospinning according to the present invention; and

FIGS. 17A and 17B illustrate a seventh embodiment of the method of manufacturing the transmission line using the nanostructured material formed through electrospinning according to the present invention.

### DETAILED DESCRIPTION

Hereinafter, exemplary embodiments of the present invention will be described in detail with reference to the attached drawings. Since embodiments disclosed in the specification and components shown in the drawings are merely exemplary embodiments of the present invention and do not represent an entirety of the technical concept of the present invention, it should be understood that a variety of equivalents and modifications capable of substituting the embodiments and the components may be present at the time of filing of the present application.

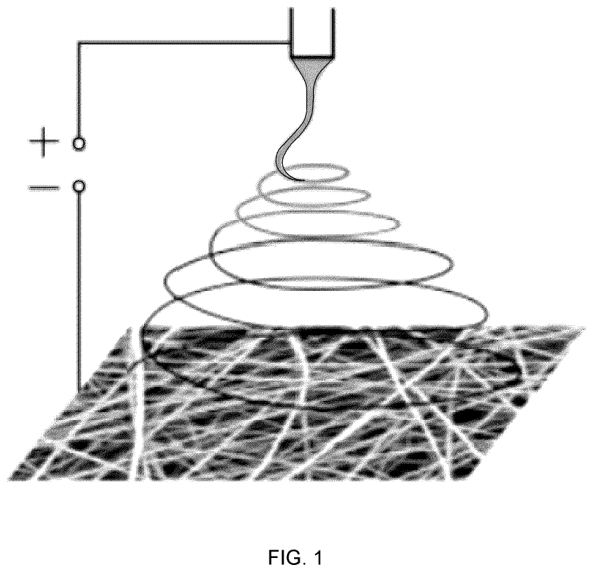

First, a nanostructured material used in a transmission line using a nanostructured material according to the present invention will be described. The nanostructured material refers to a material formed by electrospinning a liquid resin at a high voltage and will be referred to as nanoflon herein. FIG. 1 illustrates an example of an apparatus which manufactures nanoflon through electrospinning. When a polymer solution including polymers is injected into an injector and a high voltage is applied to and the polymer solution flows at a certain speed into between the injector and a substrate on which spinning is performed, as electricity is applied to a liquid suspended from an end of a capillary tube due to surface tension, a nano-sized thread is formed, and as time passes, non-woven nanofibers, which are a nanostructured material, are accumulated. A material formed by accumulating nanofibers as described above is nanoflon. As the polymer material used in electrospinning, for example, there are present polyurethane (PU), polyvinylidine diflouride (PVDF), nylon (polyamide), polyacrylonitrile (PAN), and the like. Nanoflon may be used as a dielectric of a transmission line due to low permittivity and a large amount of air therein.

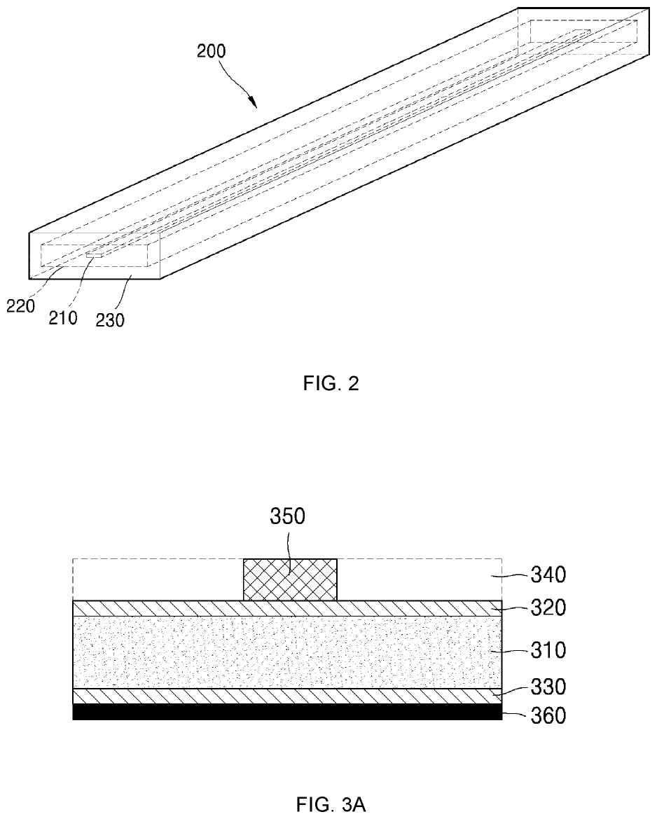

FIG. 2 illustrates an example of a stripline transmission line. Referring to FIG. 2, the stripline transmission line may include a signal line 210 transmitting a signal, a dielectric 220 surrounding the signal line 210, and a conductor 230 functioning as an outer shield.

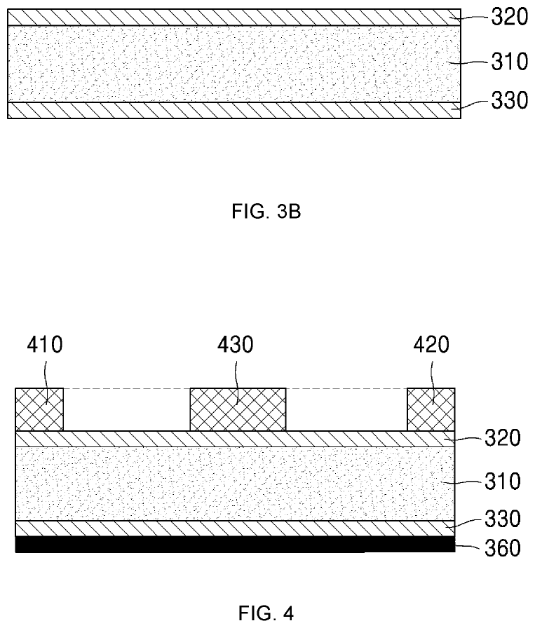

FIG. 3(a) is a cross-sectional view illustrating a first embodiment of a transmission line using a nanostructured material formed through electrospinning according to the present invention. Referring to FIG. 3(a), the first embodiment with respect to the transmission line using the nanostructured material according to the present invention includes a first nanoflon layer 310, a first coating layer 320, a second coating layer 330, a first pattern 350, and a first ground layer 360. The first nanoflon layer 310 is formed of nanoflon. As shown in FIG. 3(b), the first nanoflon layer 310 is provided while the first coating layer 320 formed of an insulating material is provided above the first nanoflon layer 310 and the second coating layer 330 formed of an insulating material is provided below the first nanoflon layer 310.

The first coating layer 320 is an insulating material and coats the top of the first nanoflon layer 310, and the second coating layer 330 is an insulating material and coats the bottom of the first nanoflon layer 310.

The insulating material is a material capable of preventing an etching solution from being absorbed, and for example, polyimide (PI), as thermally durable plastic, which is an organic polymer compound, may be used.

The first pattern 350 may be formed by etching a first conductive layer 340 formed on the first coating layer 320 and functions as a transmission line through which a signal is transmitted. Also, the first ground layer 360 is formed below the first nanoflon layer 310.

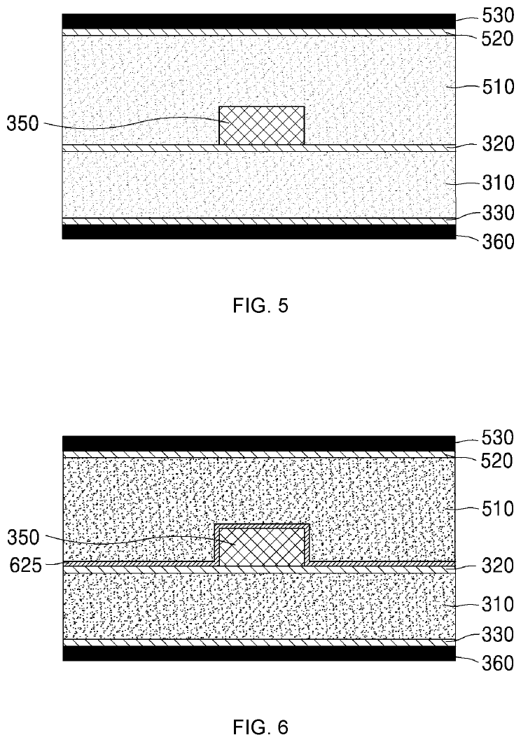

FIG. 4 is a cross-sectional view illustrating a second embodiment of the transmission line using the nanostructured material formed through electrospinning according to the present invention. Referring to FIG. 4, in the second embodiment with respect to the transmission line using the nanostructured material according to the present invention, when the first embodiment of the transmission line using the nanostructured material according to the present invention is formed, ground lines 410 and 420 are further formed and the first pattern 430 is used as a signal line. That is, the ground lines 410 and 420 and a signal line 430 are formed by etching the first conductive layer 340.

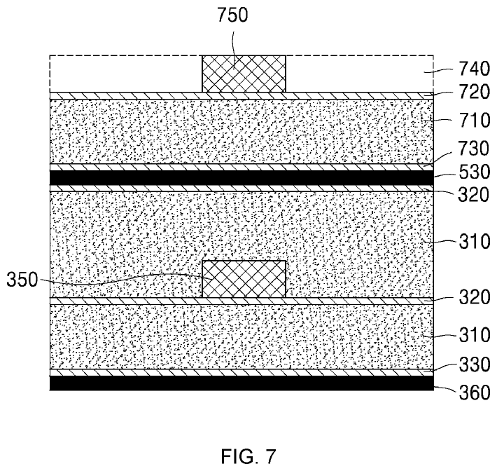

FIG. 5 is a cross-sectional view illustrating a third embodiment of the transmission line using the nanostructured material formed through electrospinning according to the present invention. Referring to FIG. 5, the third embodiment with respect to the transmission line using the nanostructured material formed through electrospinning according to the present invention further includes a second nanoflon layer 510 having a top on which a third coating layer 520 formed of an insulating material is formed and a second ground layer 530 in addition to the first embodiment (refer to FIG. 3) of the transmission line using the nanostructured material according to the present invention.

The second nanoflon layer 510 may be located above the first pattern 350 formed on the first coating layer 320 and the first coating layer 320 exposed by the etching, and may be located through adhesion. The adhesion may be performed using an adhesive tape, an adhesive, or thermal adhesion in which heat is applied to an adhesive tape). A second ground layer 530 is formed on the third coating layer 520.

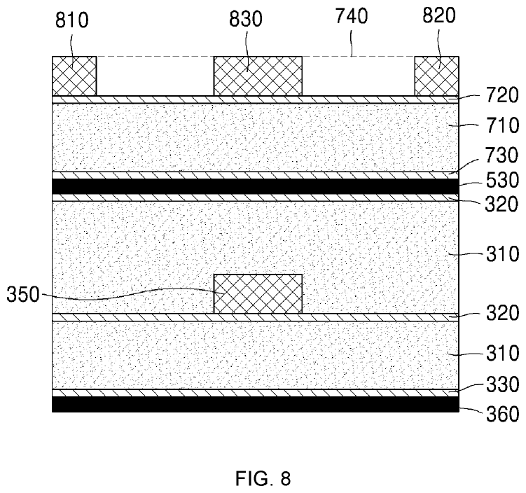

FIG. 6 is a cross-sectional view of the transmission line which illustrates adhesion to the second nanoflon layer 510 according to the present invention, and a reference numeral 625 refers to adhesion between the second nanoflon layer 510 and the first coating layer 320 and the first pattern 350.

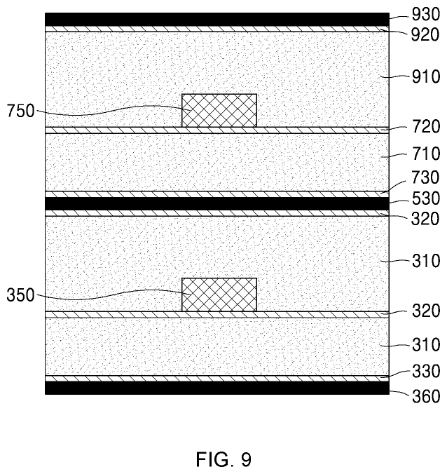

FIG. 7 is a cross-sectional view illustrating a fourth embodiment of the transmission line using the nanostructured material formed through electrospinning according to the present invention. Referring to FIG. 7, the fourth embodiment with respect to the transmission line using the nanostructured material includes a third nanoflon layer 710, above which a fourth coating layer 720 formed of an insulating material is formed and below which a fifth coating layer 730 formed of an insulating material is formed, and provided above the third embodiment of the transmission line using the nanostructured material according to the present invention.

The second pattern 750 may be formed by etching a second conductive layer 740 formed on the fourth coating layer 720 and is used as a signal line which transmits a signal.

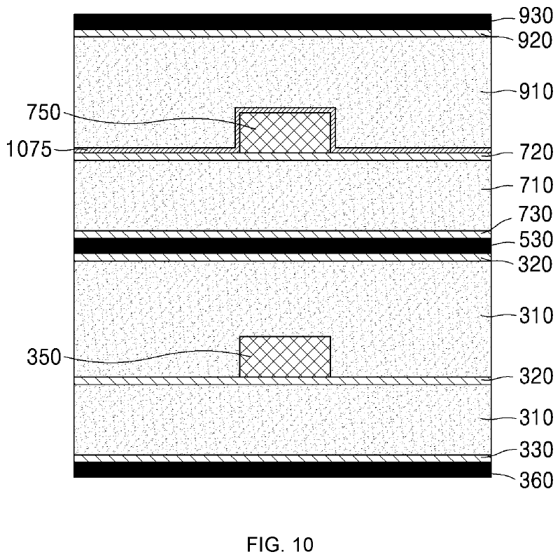

FIG. 8 is a cross-sectional view illustrating a fifth embodiment of the transmission line using the nanostructured material formed through electrospinning according to the present invention. Referring to FIG. 8, in the fifth embodiment with respect to the transmission line using the nanostructured material according to the present invention, when the fourth embodiment of the transmission line using the nanostructured material according to the present invention is formed, ground lines 810 and 820 are further formed and the second pattern 830 is used as a signal line. That is, the ground lines 810 and 820 and a signal line 830 are formed by etching the second conductive layer 740.

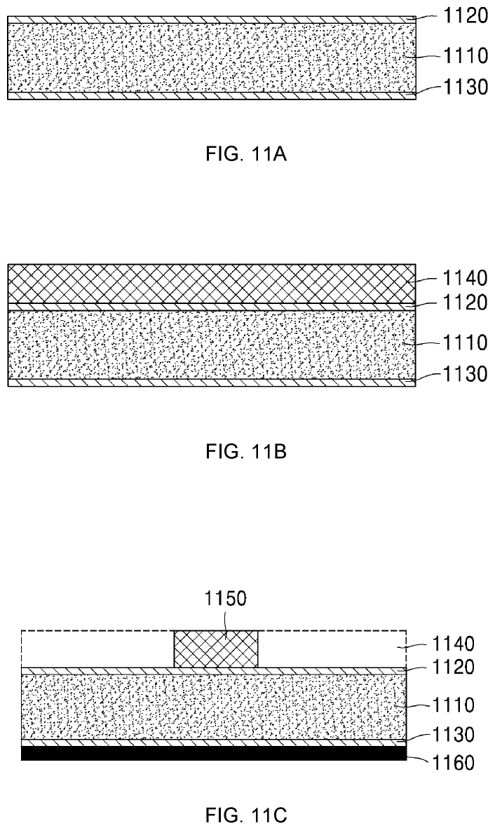

FIG. 9 is a cross-sectional view illustrating a sixth embodiment of the transmission line using the nanostructured material formed through electrospinning according to the present invention. Referring to FIG. 9, the sixth embodiment with respect to the transmission line using the nanostructured material according to the present invention further includes a fourth nanoflon layer 910 above which a sixth coating layer 920 formed of an insulating material is formed and a third ground layer 930 formed on the sixth coating layer 920.

The fourth nanoflon layer 910 may be located above the second pattern 750 formed on the fourth coating layer 720 and the fourth coating layer 720 exposed by the etching, and may be located through adhesion. The adhesion may be performed using an adhesive tape, an adhesive, or thermal adhesion in which heat is applied to an adhesive tape). The third ground layer 930 may be formed on the sixth coating layer 920.

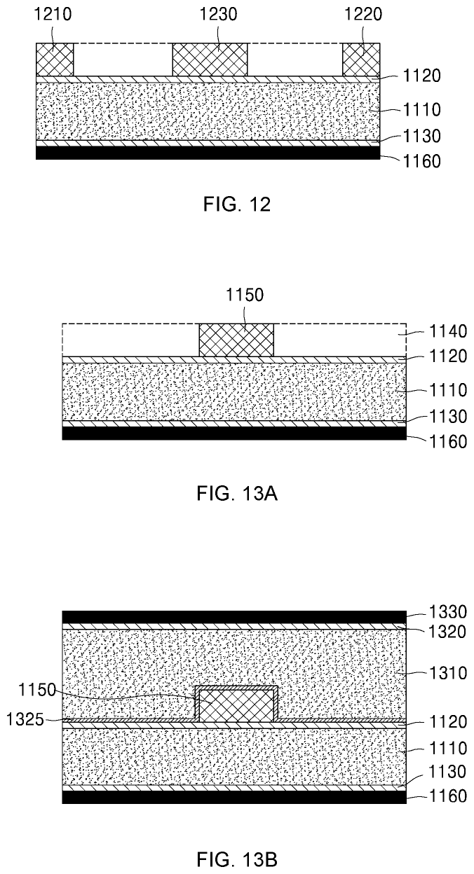

FIG. 10 is a cross-sectional view of the transmission line which illustrates adhesion to the fourth nanoflon layer 910 according to the present invention, and reference numeral 1075 refers to adhesion between the fourth nanoflon layer 910 and the fourth coating layer 720 and the second pattern 750.

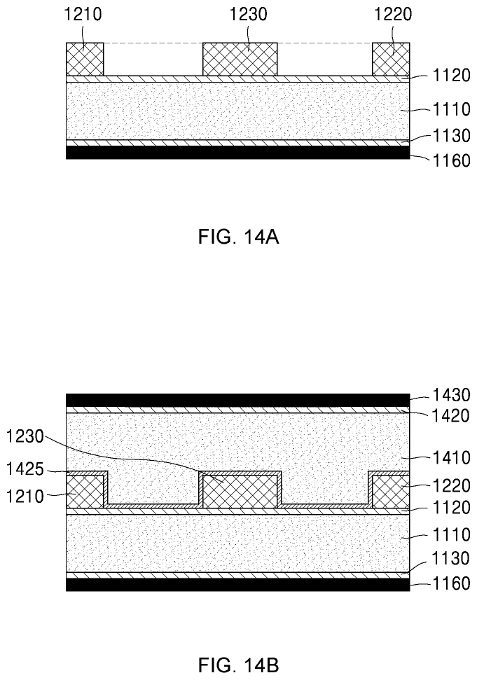

Meanwhile, FIG. 11 illustrates a first embodiment of a method of manufacturing a transmission line using a nanostructured material formed by electrospinning according to the present invention. Referring to FIG. 11(a), a top and a bottom of a first nanoflon layer 1110 formed of nanoflon are coated with an insulating material. Then, a first coating layer 1120 is formed above the first nanoflon layer 1110 and a second coating layer 1130 is formed below the first nanoflon layer 1110. Referring to FIG. 11(b), a first conductive layer 1140 is formed on the first coating layer 1120.

Referring to FIG. 11(c), a first pattern 1150, which transmits and receives a signal, is formed by etching the first conductive layer 1140. A first ground layer 1160 is located below the first nanoflon layer 1110.

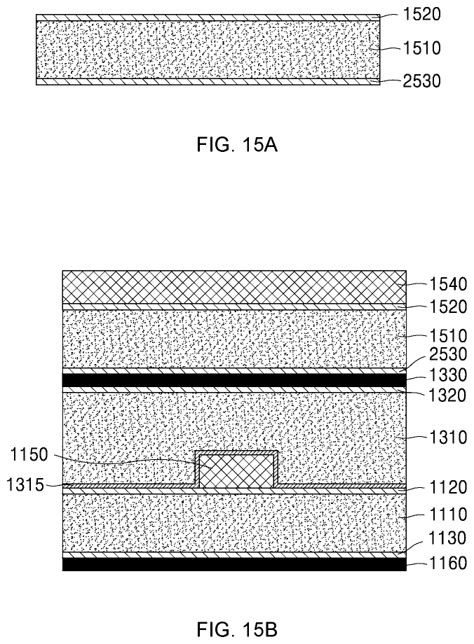

FIG. 12 illustrates a second embodiment of the method of manufacturing the transmission line using the nanostructured material formed through electrospinning according to the present invention. Referring to FIG. 12, in the second embodiment with respect to the method of manufacturing the transmission line using the nanostructured material according to the present invention, when the first embodiment of the method of manufacturing the transmission line using the nanostructured material according to the present invention is formed as shown in FIG. 11(c), ground lines 1210 and 1220 are further formed and the first pattern 1230 is used as a signal line. That is, the ground lines 1210 and 1220 and a signal line 1230 may be formed by etching the first conductor layer 1140.

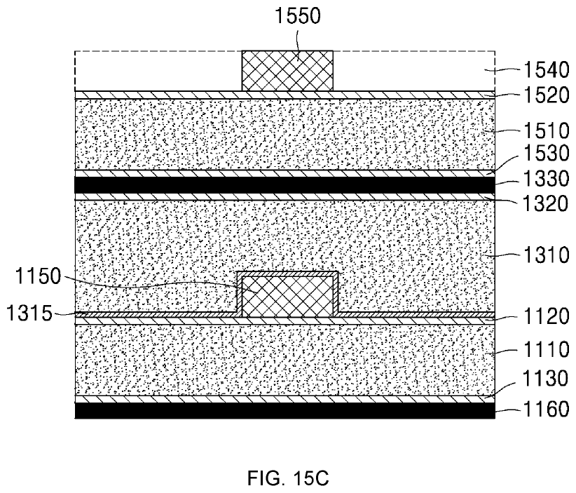

FIG. 13 illustrates a third embodiment of the method of manufacturing the transmission line using the nanostructured material according to the present invention. FIG. 13(a) illustrates a result of the first embodiment, shown in FIG. 11(c), with respect to the method of manufacturing the transmission line using the nanostructured material formed through electrospinning according to the present invention. As shown in FIG. 13(b), a second nanoflon layer 1310 having a top on which a third coating layer 1320 formed of an insulating material is formed is located on the result of the first embodiment of the method of manufacturing the transmission line. For example, the second nanoflon layer 1310 on which the third coating layer 1320 is formed may adhere (1325) to the first pattern 1150 formed on the first coating layer 1120 and the first coating layer 1120 exposed by etching in the first embodiment of the method of manufacturing the transmission line. Also, a second ground layer 1330 may be formed above the third coating layer 1320. The locating may be performed through the adhesion 1325. The adhesion 1325 may be performed using an adhesive, an adhesive, or thermal adhesion in which heat is applied to an adhesive material.

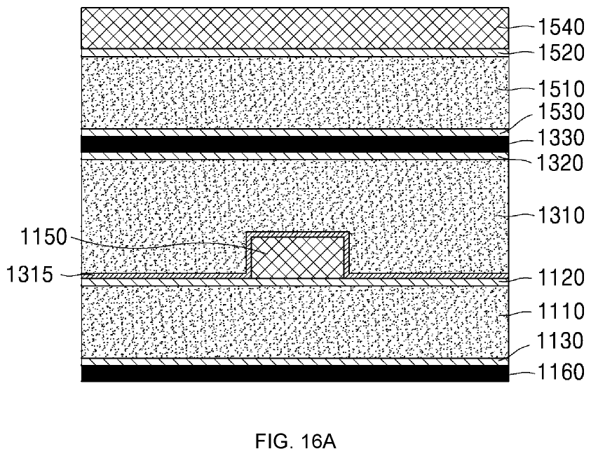

FIG. 14 illustrates a fourth embodiment of the method of manufacturing the transmission line using the nanostructured material formed through electrospinning according to the present invention. Also, FIG. 14(a) illustrates the second embodiment, shown in FIG. 12, with respect to the method of manufacturing the transmission line using the nanostructured material formed through electrospinning according to the present invention. As shown in FIG. 14(b), a second nanoflon layer 1410 having a top on which a third coating layer 1420 formed of an insulating material is formed is located on the result of the second embodiment of the method of manufacturing the transmission line. For example, the second nanoflon layer 1410 may adhere (1425) to the ground lines 1210 and 1220 and the signal line 1230 formed on the first coating layer 1120 and the first coating layer 1120 exposed by the etching in the second embodiment of the method of manufacturing the transmission line. The adhesion 1425 may be performed using an adhesive, an adhesive, or thermal adhesion in which heat is applied to an adhesive material. Also, a second ground layer 1430 may be formed on the third coating layer 1420.

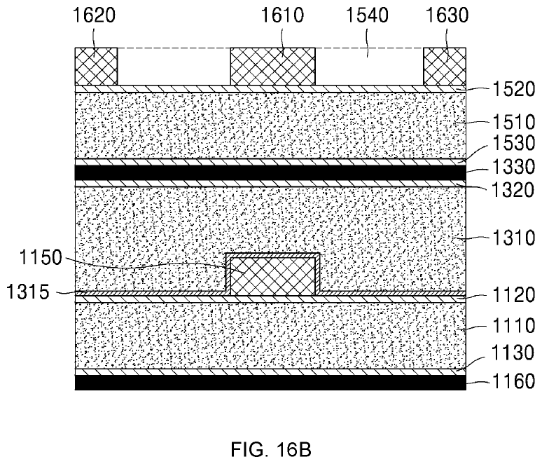

FIGS. 15a, 15b, and 15c illustrate a fifth embodiment of the method of manufacturing the transmission line using the nanostructured material formed through electrospinning according to the present invention. Referring to FIG. 15a, a top and a bottom of a third nanoflon layer 1510 formed of nanoflon are coated with an insulating material. Then, a fourth coating layer 1520 is formed above the third nanoflon layer 1510 and a fifth coating layer 1530 is formed below the third nanoflon layer 1510.

Referring to FIG. 15b, the third nanoflon layer 1510, above which the fourth coating layer 1520 is formed and below which the fifth coating layer 1530 is formed as shown in FIG. 15a, is located above the second ground layer 1330 of the transmission line which is a result of the third embodiment of the present invention shown in FIG. 13b. Then, a second conductive layer 1540 is formed on the fourth coating layer 1520. Referring to FIG. 15c, the second conductive layer 1540 is formed on the fourth coating layer 1520 and then a second pattern 1550, which transmits and receives a signal, is formed by etching the second conductive layer 1540.

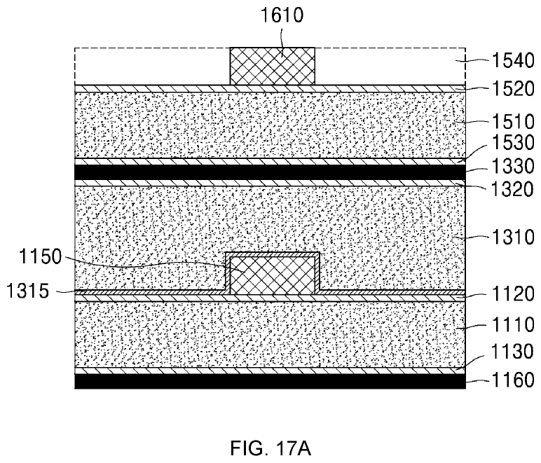

FIGS. 16a and 16b illustrate a sixth embodiment of the method of manufacturing the transmission line using the nanostructured material formed through electrospinning according to the present invention. FIG. 16a illustrates the second conductive layer 1540 being formed on the fourth coating layer 1520 in the fifth embodiment as shown in FIG. 15b. Referring to FIG. 16b, the second conductive layer 1540 is formed on the fourth coating layer 1520 and then a signal line 1610, which transmits and receives a signal, and ground lines 1620 and 1630 are formed by etching the second conductive layer 1540.

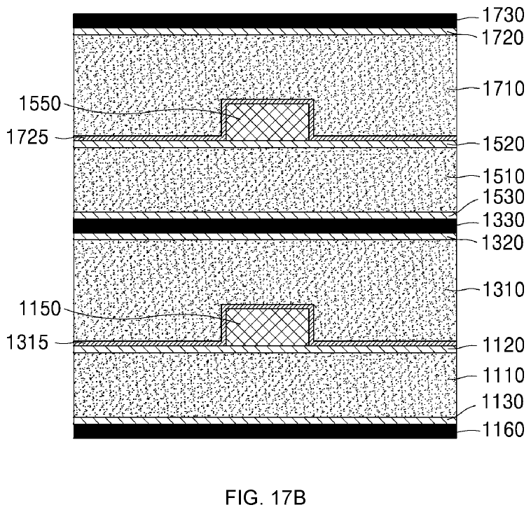

FIGS. 17a and 17b illustrate a seventh embodiment of the method of manufacturing the transmission line using the nanostructured material formed through electrospinning according to the present invention. FIG. 17a illustrates a result of the fifth embodiment, shown in FIG. 15c, with respect to the method of manufacturing the transmission line using the nanostructured material formed through electrospinning according to the present invention. As shown in FIG. 17b, a fourth nanoflon layer 1710 having a top on which a sixth coating layer 1720 formed of an insulating material is formed is located on the result of the fifth embodiment of the method of manufacturing the transmission line. For example, the fourth nanoflon layer 1710 on which the sixth coating layer 1720 is formed may adhere (1725) to the second pattern 1550 formed on the fifth coating layer 1520 and the fifth coating layer 1520 exposed by the etching. Then, a third ground layer 1730 may be formed on the sixth coating layer 1720. The locating may be performed through the adhesion 1725. The adhesion 1725 may be performed using an adhesive, an adhesive, or thermal adhesion in which heat is applied to an adhesive material.

According to the embodiments of the present invention, in a transmission line using coating of a nanostructured material and a method of manufacturing the transmission line, a nanostructured material formed by electrospinning a resin at a high voltage is used as a dielectric of a transmission line such that the permittivity of the dielectric of the transmission line may be low and a loss tangent value may be reduced at the low permittivity.

Particularly, the transmission line according to the embodiments of the present invention may be used as a low-loss flat cable for reducing a transmission loss of a high frequency signal in a band from 3.5 GHz and 28 GHz used in a five generation (5G) mobile communication network.

Although the present invention has been described with reference to the embodiments shown in the drawings, it should be understood that the embodiments are merely examples and a variety of modifications and equivalents thereof may be made by one of ordinary skill in the art. Therefore, the technical scope of the present invention should be defined by the technical concept of the attached claims.

1. A transmission line using a nanostructured material, comprising:
a first nanoflon layer formed of nanoflon, above which a first coating layer formed of an insulating material is formed, and below which a second coating layer formed of an insulating material is formed;
a first pattern formed by a first conductive layer formed on the first coating layer; and
a first ground layer formed below the second coating layer,
wherein the nanoflon is a nanostructured material formed by electrospinning a liquid resin at a high voltage.

2. The transmission line of claim 1, wherein the first pattern comprises ground lines and a signal line, which are formed by etching the first conductive layer.

3. The transmission line of claim 1, further comprising:
a second nanoflon layer located on the first pattern formed on the first coating layer and the first coating layer exposed by the etching and above which a third coating layer formed of an insulating material is provided; and
a second ground layer formed on the third coating layer.

4. The transmission line of claim 1, further comprising:
a second nanoflon layer located on the first pattern formed on the first coating layer and the first coating layer exposed by the etching and above which a third coating layer formed of an insulating material is formed;
a second ground layer formed on the third coating layer;
a third nanoflon layer formed on the second ground layer, above which a fourth coating layer formed of an insulating material is provided, and below which a fifth coating layer formed of an insulating material is provided;
a second conductive layer formed on the fourth coating layer; and
a second pattern formed by etching the second conductive layer and configured to transmit a signal.

5. The transmission line of claim 4, wherein the second pattern comprises ground lines and a signal line configured to transmit a signal, which are formed by etching the second conductive layer.

6. The transmission line of claim 4, further comprising:
a fourth nanoflon layer located on the second pattern formed on the fourth coating layer and the fourth coating layer exposed by the etching and above which a sixth coating layer formed of an insulating material is provided; and
a third ground layer formed on the sixth coating layer.

7. The transmission line according to claim 4, wherein the locating is adhesion using an adhesive tape, an adhesive, or thermal adhesion in which heat is applied to an adhesive tape.

8. The transmission line according to claim 1, wherein the first to sixth coating layers are polyimide (PI), and the conductive layers are copper (Cu).

9. A method of manufacturing a transmission line using a nanostructured material formed through electrospinning, the method comprising:
forming a first coating layer and a second coating layer on a top and a bottom of a first nanoflon layer formed of nanoflon, respectively, by coating the top and bottom with an insulating material;
forming a first conductive layer on the first coating layer;
forming a first pattern, which transmits and receives a signal, by etching the first conductive layer; and
forming a first ground layer on the second coating layer,
wherein the nanoflon is a nanostructured material formed by electrospinning a liquid resin at a high voltage.

10. The method of claim 9, wherein the forming of the first pattern comprises forming ground lines and a signal line by etching the first conductive layer.

11. The method of claim 9, further comprising:
locating a second nanoflon layer located on the first pattern formed on the first coating layer and the first coating layer exposed by the etching and above which a third coating layer formed of an insulating material is provided; and
forming a second ground layer formed on the third coating layer.

12. The method of claim 10, further comprising:
locating a second nanoflon layer located on the first pattern formed on the first coating layer and the first coating layer exposed by the etching and above which a third coating layer formed of an insulating material is provided; and
forming a second ground layer formed on the third coating layer.

13. The method of claim 12, further comprising:
forming a fourth coating layer and a fifth coating layer on a top and a bottom of a third nanoflon layer formed of nanoflon, respectively, by coating the top and bottom with an insulating material;
forming the third nanoflon layer on the second ground layer, above which the fourth coating layer is formed and below which the fifth coating layer is formed;
forming a second conductive layer on the fourth coating layer; and
forming a second pattern, which transmits and receives a signal, by etching the second conductive layer.

14. The method of claim 13, further comprising:
locating a fourth nanoflon layer, above which a sixth coating layer formed of an insulating material is formed, on the second pattern formed on the fourth coating layer and the fourth coating layer exposed by the etching; and
forming a third ground layer on the fourth nanoflon layer.

15. The method according to claim 13, wherein the locating is adhesion using an adhesive tape, an adhesive, or thermal adhesion in which heat is applied to an adhesive tape.
